(19) United States
(12) Patent Application Publication
(10) Pub. No.: US 2010/0077209 A1
(43) Pub. Date: Mar. 25, 2010

(54) GENERATING HARD INSTANCES OF CAPTCHAS

(75) Inventors: Andrei BRODER, Menlo Park, CA (US); Shanmugasundaram RAVIKUMAR, Berkeley, CA (US)

Correspondence Address: Weaver Austin Villeneuve & Sampson - Yahoo!, P.O. BOX 70250, OAKLAND, CA, 94612-0250, US

(73) Assignee: YAHOO! INC, Sunnyvale, CA (US)

(21) Appl. No.: 12/236,869

(22) Filed: Sep. 24, 2008

(51) Int. Cl. H04L 9/00

(52) U.S. Cl. 713/168

(57) ABSTRACT

Methods and systems are described for enhancing the difficulty of captchas and enlarging a core of available captchas that are hard for an automated or robotic user to crack.

### CROSS REFERENCE TO RELATED APPLICATIONS

The present application is related to cop ending application Ser. No. ______, attorney docket No. YAH1P186/Y04656US01, entitled “Captcha Image Generation,” having the same inventors and filed concurrently herewith, which is hereby incorporated by reference in the entirety.

### BACKGROUND OF THE INVENTION

This invention relates generally to accessing computer systems using a communication network, and more particularly to accepting service requests of a server computer on a selective basis.

The term “Captcha” is an acronym for “Completely Automated Public Turing test to tell Computers and Humans Apart”.

Captchas are protocols used by interactive programs to confirm that the interaction is happening with a human rather than with a robot. They are useful when there is a risk of automatic programs masquerading as humans and carrying out the interactions. One such typical situation is the registration of a new account in an online service, e.g., Yahoo! Without captchas, spammers can create fake registrations and use them for malicious purposes. Captchas are typically implemented by creating a pattern recognition task that is relatively easy for humans but hard for computerized programs; this includes image recognition, speech recognition, etc.

Since their invention, captchas have been reasonably successful in deterring spammers from creating fake registrations. However, the spammers have caught up with the captcha technology by developing programs that can “break” the captchas with reasonable accuracy. Hence, it is important to stay ahead of the spammers by improving the captcha mechanism and push the spammers' success rate as low as possible.

### SUMMARY OF THE INVENTION

According to the present invention, techniques are provided for minimizing robotic usage and spam traffic of a service. In the instance that the service is email, the disclosed embodiments are particularly advantageous. They are adaptive and can dynamically track the algorithmic improvements made by spammers, assuming spammers are relatively accurately distinguished from humans. Hard core captchas can be used to learn patterns that are harder than the current spammer algorithms. By learning the patterns, the size of the hard-core set is effectively enlarged.

One aspect of a disclosed embodiment relates to a computer-implemented method for modifying a set of captchas based on responses to the captchas from one or more client computers. The method comprises classifying first ones of the responses as coming from an automated process and second ones of the responses as coming from a human, modifying a first one of the captchas for which the first responses represent a corresponding success rate higher than a first threshold, and eliminating a second one of the captchas from the set of captchas for which the second responses represent a corresponding failure rate above a second threshold.

Another aspect of a disclosed embodiment relates to a computer system for selectively accepting access requests to a service. The computer system is configured to determine a hard set of captchas from a plurality of possible captchas, render some or all of the hard set of captchas on a computing device, receive responses to the rendered hard set of captchas, track the received responses to the rendered hard set of captchas, distinguish between responses believed to be entered by a human and responses believed to be entered by an automated client, and eliminate a group of the hard set of captchas, the eliminated group having a failure rate of response above an acceptable threshold for those responses believed to be entered by a human.

Yet another aspect of a disclosed embodiment relates to a computer-implemented method for selectively accepting access requests from a client computer connected to a server computer. The method comprises presenting a plurality of captchas to a plurality of users wishing to access a service, receiving answers to the captchas, monitoring registration for the service by a user and determining if registration characteristics of the user are correlated with characteristics of a robotic user, monitoring the post registration use of the service by a user and determining if post registration usage characteristics of the user are correlated with usage characteristics of a robotic user, assessing the answers to the captchas and tracking correct and incorrect of the answers, and classifying the captchas that receive incorrect answers from a suspected robotic user for inclusion in a hard set.

A further understanding of the nature and advantages of the present invention may be realized by reference to the remaining portions of the specification and the drawings.

### BRIEF DESCRIPTION OF THE DRAWINGS

FIG. 1 is a simplified flow chart illustrating operation of a specific embodiment of the invention.

FIG. 2 is a flowchart illustrating in more detail some steps of the flowchart of FIG. 1.

FIG. 3 is flow chart illustrating operation of another embodiment of the invention.

FIG. 4 is a simplified diagram of a computing environment in which embodiments of the invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As mentioned previously, Captchas are protocols used by interactive programs to confirm that the interaction is happening with a human rather than with a robot. For further information on a Captcha implementation, please refer to U.S. Pat. No. 6,195,698 having inventor Andrei Broder in common with the present application, which is hereby incorporated by reference in the entirety.

Since their invention, captchas have been reasonably successful in deterring spammers from creating fake registrations. However, the spammers have caught up with the captcha technology by developing programs that can “break” the captchas with reasonable accuracy. Embodiments of the present invention utilize an adaptive approach to make breaking captchas harder for the spammers. A hard captcha is a captcha that is empirically determined to be difficult to crack by a user, whether a human or a robotic user (“bot”). Embodiments of the invention distinguish suspected bots from humans, and classify answers that cannot be cracked by a bot (to a reasonable extent) as hard captchas. A hard core is a set of hard captchas. Certain embodiments expand the hard core by modifying captchas of the core. Hard captchas that prove overly difficult for humans may be eliminated from usage.

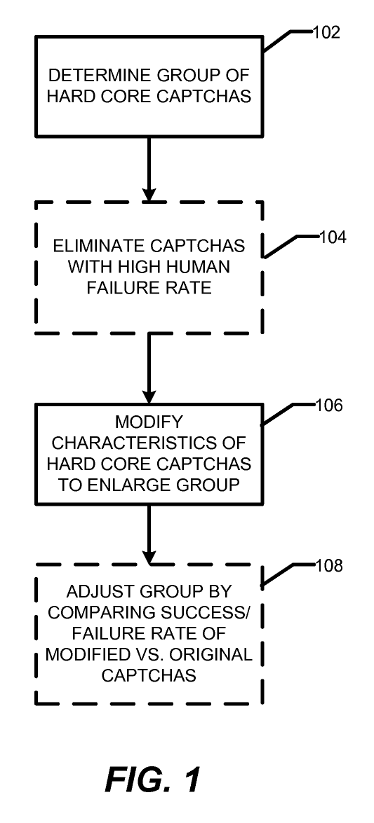

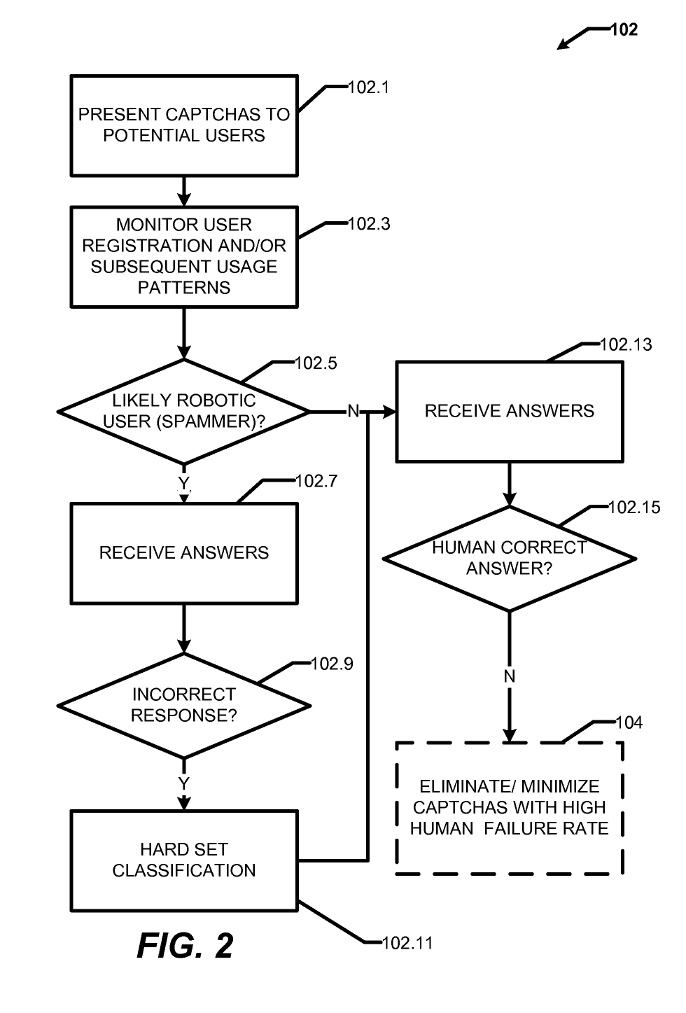

FIG. 1 is a simplified flow chart illustrating operation of a specific embodiment of the invention. In step 102, a core group of hard captchas is determined, which will be discussed in greater detail below with regard to FIG. 2. A captcha will ideally thwart all automated processes or bots while human users will be able to determine the underlying riddle of the captcha. In reality, some of the captchas of the hard core will prove to have a high failure rate with both bots and with humans alike. While deterring the automated registration for a service by a bot is desirable, it is undesirable to deter human usage. In step 104, which is optional, those captchas within the hard core that have an undesirable human failure rate may be removed from the hard core. If the human failure rate is above an acceptable threshold, for example above anywhere from 20-80%, a captcha may be removed from the hard core or otherwise not further utilized. This may be determined via a control group or from actual usage statistics, based on characteristics indicative of human and bot usage. Then in step 106, characteristics of a captcha are modified in order to generate additional hard captchas and enlarge the number of captchas within the hard core (as will be discussed in greater detail below).

Optionally, in step 108 some of the original and/or the modified captchas may be eliminated based on a comparison between the success/failure rate of an original vs. the modified captcha(s). For example, if the modified captchas turn out to be relatively easy for spammers, it indicates that the difficulty was only due to the particular mask being used so the original captcha may be removed from the hard set. Conversely if the equivalent captcha turns out to be hard for spammers as well, the original captcha is, preferably, kept in the set.

One specific embodiment of step 102 of FIG. 1 is described in more detail in FIG. 2. Process 102 is applicable to all forms of captchas, not simply those captchas comprising graphical representations of strings. For example, process 102 is applicable to audio captchas. In step 102.1, captchas are presented to potential users of a service, for example Yahoo! Mail. Then, in step 102.3, users of the service are monitored. This may include monitoring and analyzing the registration and subsequent usage patterns. Bots are often utilized by spammers to send out mass emails or accomplish other repetitive tasks quickly. Although it is understood that bots have widespread applications for a variety of applications, only one of which is to send unwanted or “spam” email, for simplicity the term spammer may be utilized interchangeably with the term bot.

In one embodiment, a classifier or classification system is employed that, given all the details of a registration, can determine with high accuracy whether a user is a spammer or a genuine human user. This classifier can then be used to track all the “unsuccessful” captcha decoding attempts from the identified spammers as discussed with regard to the specific steps below. The classifier can be constructed from simple clues such as the user ids, first and last names, IP and geo-location, time of the day, and other registration information using standard machine learning algorithms.

Alternatively, if spammers cannot be detected during the registration process, but can be discovered later, through their actions (e.g. excessive or malicious e-mail, excessive mail-send with no corresponding mail-receive, etc.) the method/system can keep track of all the captchas solved and unsolved by such users. Then the captchas that were not decoded by spammers can be separated.

Referring again to FIG. 2, in step 102.5, the system assesses whether the user is likely a spammer or a legitimate human user according to the aforementioned criteria. If the user is classified as a spammer, the system will then monitor the spammer's answers as seen in step 102.7. If the spammer answers incorrectly, as seen in step 102.9, the captcha will then be classified for inclusion in the hard set or core of captchas. As it is not possible to determine with absolute certainty that a user is a spammer, a threshold may be employed. For example, in one embodiment, if users believed to be spammers answer incorrectly approximately 60-100% of the time, the captchas will then be classified for inclusion in the hard set or core of captchas. Answers submitted by users classified as humans will also be received and evaluated as seen in steps 102.13 and 102.15. This can be done before or after a captcha is included in the hard set. Preferably, captchas with a high human failure rate are not utilized, as seen again in step 104.

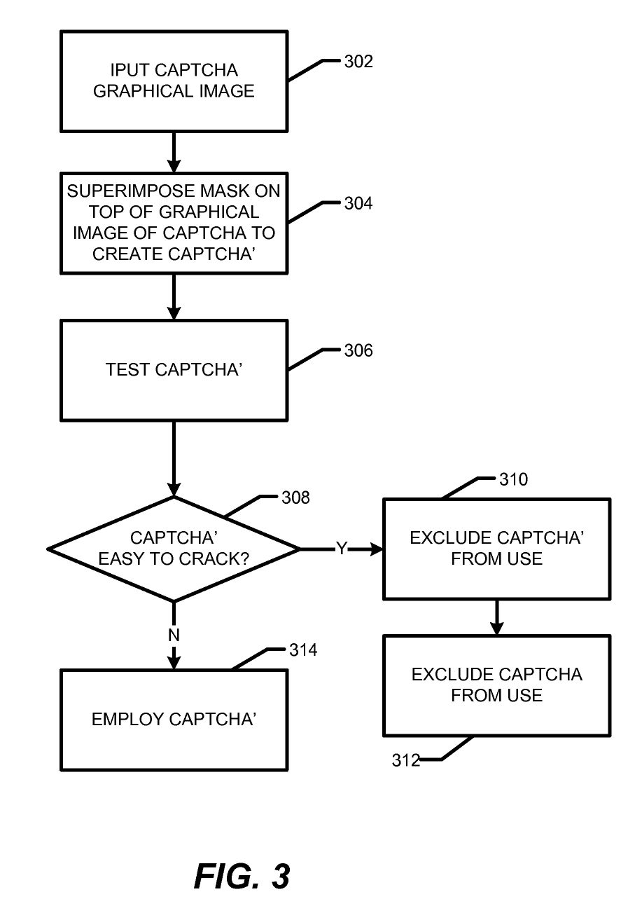

FIG. 3 is flow chart illustrating one specific embodiment of modifying characteristics of a captcha to enlarge the number of available captchas, as seen in step 106 in FIG. 1. This example relates to string-image captchas. In step 302 the system inputs the graphical image of the captcha. This input may be a captcha previously determined to be part of the hard core, in which case the hard core will be expanded and optionally refined. Alternatively, this input may be an untested captcha. In step 304, a mask is superimposed on top of the captcha image to create a new captcha, i.e., captcha' (prime). The mask may be larger or smaller than the captcha image, but is preferably of the same pixel dimension (that is, it contains one pixel for each pixel of the original picture) as the input captcha. Three types of pixels may be employed:

a. Transparent. For such pixels the superimposed pixel is the same as the original pixel.

b. White. For such pixels the superimposed pixel is always white.

c. Black. For such pixels the superimposed pixel is always black.

In one embodiment, the mask contains a large number of relatively small “splotches” of white and black. The splotches are randomly generated. The density of these splotches is chosen appropriately so as to maintain the ability of humans to recognize the string. Other patterns may be also employed. For example, blurring or texture changes to the image may be performed, or noise may be inserted into the image. Such changes will prevent a spammer from recognizing an identical image.

The captcha' is then tested in step 306. If the captcha' is determined to be easy to crack, as seen in step 308, it is excluded from use in step 310. If alternatively the captcha' is not easy to crack, it is employed, as seen in step 314. In one embodiment, the testing in step 306 comprises not only the raw success/failure rate statistics, but also a comparison between the success/failure rates of human vs. robotic users. For example, the percentage of accurate responses from users to both the original captcha to one or more iterations of captcha' can be compared. If the accurate response rate or ratio of the accurate response rate of the modified captcha (captcha') to original captcha drops below an acceptable threshold, e.g. below anywhere from 20-80%, the modified captcha can be altered again or removed from usage.

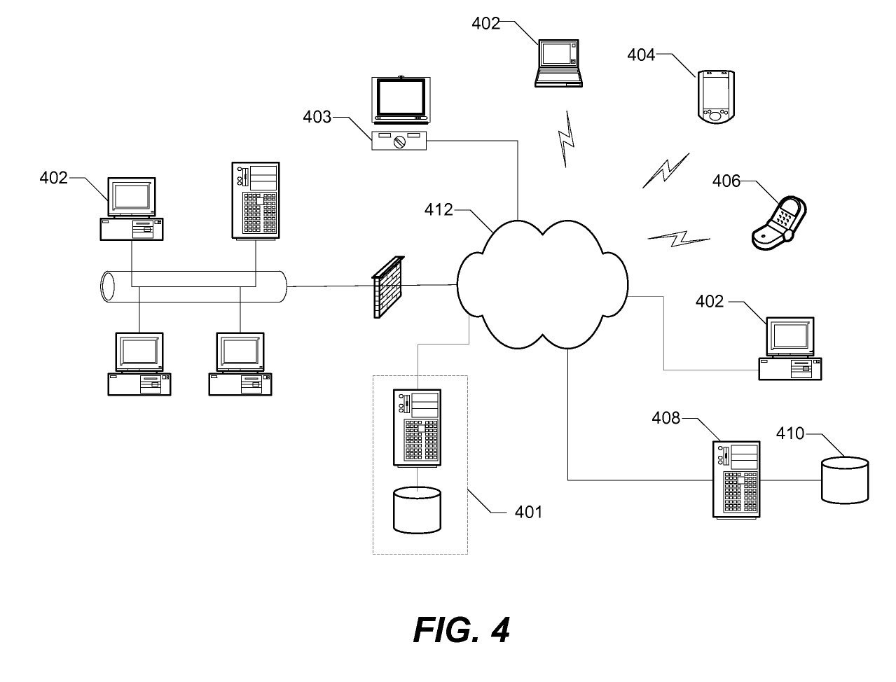

FIG. 4 is a simplified diagram of a computing environment in which embodiments of the invention may be implemented.

For example, as illustrated in the diagram of FIG. 4, implementations are contemplated in which a population of users interacts with a diverse network environment, using search services, via any type of computer (e.g., desktop, laptop, tablet, etc.) 402, media computing platforms 403 (e.g., cable and satellite set top boxes and digital video recorders), mobile computing devices (e.g., PDAs) 404, cell phones 406, or any other type of computing or communication platform. The population of users might include, for example, users of online search services such as those provided by Yahoo! Inc. (represented by computing device and associated data store 401).

Regardless of the nature of the text strings in a captcha or the hard core, or how the text strings are derived or the purposes for which they are employed, they may be processed in accordance with an embodiment of the invention in some centralized manner. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

Embodiments may be characterized by several advantages. They are adaptive and can dynamically track and respond to the algorithmic improvements made by spammers. Techniques enabled by the present invention can be used to learn patterns that are hard for the current spammer algorithms. By learning these patterns, the size of the hard-core set may be effectively enlarged.

To avoid the situation where spammers manually construct solutions to hard-captchas, minor distortions can be performed on subsequent use of hard-core captchas. These distortions will still preserve the hardness.

While the invention has been particularly shown and described with reference to specific embodiments thereof, it will be understood by those skilled in the art that changes in the form and details of the disclosed embodiments may be made without departing from the spirit or scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for modifying a set of captchas based on responses to the captchas from one or more client computers, comprising:
classifying first ones of the responses as coming from an automated process and second ones of the responses as coming from a human;
modifying a first one of the captchas for which the first responses represent a corresponding success rate higher than a first threshold; and
eliminating a second one of the captchas from the set of captchas for which the second responses represent a corresponding failure rate above a second threshold.

2. The method of claim 1, further comprising adding new captchas determined to be difficult for an automated process but not for humans.

3. The method of claim 1, further comprising deriving the set of captchas from a larger group of captchas.

4. The method of claim 1, further comprising:
monitoring the use of a service by a user and determining if usage characteristics of the user are correlated with usage characteristics of an automated robotic user.

5. The method of claim 4, wherein usage characteristics comprise registration attributes, and wherein monitoring the use comprises monitoring registration attributes.

6. The method of claim 4 wherein usage characteristics comprise post registration usage of the service, and wherein monitoring the use comprises monitoring the post registration usage of the service.

7. A computer system for selectively accepting access requests to a service, the computer system configured to:
determine a hard set of captchas from a plurality of possible captchas;
render some or all of the hard set of captchas on a computing device;
receive responses to the rendered hard set of captchas;
track the received responses to the rendered hard set of captchas;
distinguish between responses believed to be entered by a human and responses believed to be entered by an automated client; and
eliminate a group of the hard set of captchas, the eliminated group having a failure rate of response above an acceptable threshold for those responses believed to be entered by a human.

8. The computer system of claim 7 wherein in order to distinguish between responses believed to be entered by a human and responses believed to be entered by an automated client the computer system is configured to determine if usage characteristics of the user are correlated with usage characteristics of an automated robotic user.

9. The computer system of claim 8, wherein usage characteristics comprise registration attributes, and wherein the computer system is configured to monitor registration attributes.

10. The computer system of claim 8, wherein usage characteristics comprise post registration usage of the service, and wherein the computer system is configured to monitor the post registration usage of the service.

11. A computer-implemented method for selectively accepting access requests from a client computer connected to a server computer, comprising:
presenting a plurality of captchas to a plurality of users wishing to access a service;
receiving answers to the captchas;
monitoring registration for the service by a user and determining if registration characteristics of the user are correlated with characteristics of a robotic user;
monitoring the post registration use of the service by a user and determining if post registration usage characteristics of the user are correlated with usage characteristics of a robotic user;
assessing the answers to the captchas and tracking correct and incorrect of the answers; and
classifying the captchas that receive incorrect answers from a suspected robotic user for inclusion in a hard set.

12. A computer-implemented method, comprising:
causing an original set of captchas to be rendered on a first plurality of client computers; and
causing a modified set of captchas to be rendered on a second plurality of client computers, the modified set of captchas including a modified captcha corresponding to a first captcha from the original set of captchas, the modified captcha having been modified as a result of responses to the first captcha by automated processes, the modified captcha being more difficult for the automated processes to successfully process.
